(19) United States
(12) Patent Application Publication
(10) Pub. No.: US 2007/0068967 A1
(43) Pub. Date: Mar. 29, 2007

(54) Push-type dispensing device

(76) Inventor: Jung-Hyun Kee, Incheon (KR)

Correspondence Address: F. CHAU & ASSOCIATES, LLC, 130 WOODBURY ROAD, WOODBURY, NY, 11797, US

(21) Appl. No.: 10/581,013

(22) PCT Filed: Jan. 11, 2005
(86) PCT No.: PCT/KR05/00083

§ 371 Date: May 30, 2006

(30) Foreign Application Priority Data
Jun. 30, 2004 (KR) 20-2004-0018524

(51) Int. Cl. B67D 5/64

(52) U.S. Cl. 222/162

(57) ABSTRACT

A push-type dispensing device is disclosed. The dispensing device includes an outer casing (10). A nozzle cap (20) is fastened to a lower end of the outer casing. An inner casing (30) is housed in the outer casing, contains contents, and moves vertically. A button (40) is coupled to an upper end of the inner casing and actuated to move the inner casing downwards. A dispenser (50) is coupled to a lower end of the inner casing and dispenses a prescribed amount of contents by a pumping action. An elastic spring (60) is interposed between a cylinder cap and the nozzle cap, and elastically restores the inner casing to an original position thereof. A plunger (70) is in close contact with an inner surface of the inner casing, and pushes the contents toward the dispenser when the contents are dispensed.

### TECHNICAL FIELD

The present invention relates, in general, to a dispensing device to hold cosmetic contents therein and, more particularly, to a push-type dispensing device, which is similar in construction to a mechanical pencil, and is constructed so that a button is mounted to an upper end of a casing having the shape of a barrel with a predetermined length, and a dispenser is mounted to a lower end of the casing and is actuated when the button is pushed, thus dispensing a small amount of contents.

### BACKGROUND ART

As is generally known, a dispensing device is constructed so that a hermetic casing holds contents, such as cosmetics, and a dispenser is secured to a mouth of the casing. Thereby, by a pumping action of the dispenser, a prescribed amount of contents is discharged.

In a detailed description, the conventional dispensing device includes the hermetic casing, the dispenser, and a button. The hermetic casing holds contents therein and is opened at an upper portion thereof. The dispenser is secured to an upper end of the casing, and dispenses a prescribed amount of contents by the pumping action. Further, the button is coupled to an upper end of the dispenser, with a nozzle protruding from an end of the button.

The conventional dispensing device is operated as follows. That is, when a user pushes the button provided on the upper end of the dispensing device, the dispenser provided under the button is operated, thus forcing the contents held in the hermetic casing to flow upwards. The contents are discharged through the nozzle which protrudes from an end of the button.

Such a conventional dispensing device is constructed so that contents are discharged through an end of the upper portion of the dispensing device by the operation of the dispenser. Thus, a user pushes the button with one hand while receiving the contents discharged through an end of the button with the other hand. Thereafter, the user rubs two hands against each other to distribute the contents uniformly. In such a state, the user applies the cosmetic to a desired portion.

As such, the discharged contents are applied to both hands, thus wasting the contents. Especially, in the case of an expensive cosmetic provided in a small quantity, the relative quantity of the cosmetic applied to a user's hands is large, so that it is uneconomical and inefficient.

### DISCLOSURE

### Technical Problem

Accordingly, the present invention has been made keeping in mind the above problems occurring in the prior art, and an object of the present invention is to provide a push-type dispensing device, which is similar in construction to a mechanical pencil, and is constructed so that a button is mounted to an upper end of a casing having the shape of a barrel with a predetermined length, and a dispenser is mounted to a lower end of the casing and is actuated when the button is pushed, thus dispensing a small amount of contents.

Another object of the present invention is to provide a push-type dispensing device having a structure similar to a mechanical pencil, which is easy to store and display, and is configured to prevent the entry of foreign materials and air through a nozzle when the dispensing device is not in use.

### Technical Solution

In order to accomplish the above objects, the present invention provides a push-type dispensing device, including an outer casing having a barrel shape which is opened at upper and lower ends thereof and has a predetermined length; a nozzle cap having a hollow cone shape, and being fastened to a lower end of the outer casing, with an orifice formed at a center of the nozzle cap; an inner casing housed in the outer casing, containing contents, such as cosmetics, and moving up and down by a predetermined distance; a button coupled to an upper end of the inner casing to protrude upwards from the outer casing by a predetermined height, and actuated to move the inner casing downwards; a dispenser coupled to a lower end of the inner casing, with a pump stem being provided on the dispenser such that a lower end of the pump stem is in close contact with the orifice, the dispenser dispensing a prescribed amount of contents by a pumping action of the pump stem and a piston; an elastic spring interposed between a cylinder cap and the nozzle cap while surrounding the pump stem of the dispenser, and restoring the inner casing to an original position thereof using elasticity of the elastic spring when the inner casing has moved downwards; and a plunger provided in the inner casing to be in close contact with an inner surface of the inner casing, and pushing the contents toward the dispenser when the prescribed amount of contents is dispensed.

A guide groove having a predetermined vertical length is provided on an inner circumferential surface of an upper portion of the outer casing, and a guide protrusion is provided around a lower end of the button to correspond to the guide groove, thus, in cooperation with the guide groove, limiting vertical movement of the inner casing.

Further, the dispensing device further includes a stand, having a seating recess defined in a center of the stand so that the nozzle cap is tightly inserted into the seating recess, thus safely supporting and standing the dispensing device; a support step provided along an upper end of the seating recess so that an outer circumference of an upper end of the outer casing is seated on the support step, thus supporting the dispensing device; and a support piece extending upwards from an outer edge of the support step to a predetermined height, and supporting an outer circumferential surface of the standing dispensing device.

### DESCRIPTION OF DRAWINGS

FIG. 1 is an exploded perspective view of a push-type dispensing device, according to an embodiment of the present invention;

FIG. 2 is a side sectional view of the push-type dispensing device, according to an embodiment of the present invention;

FIG. 3 shows the operation of the push-type dispensing device, according to an embodiment of the present invention;

FIG. 4 is an exploded perspective view of a push-type dispensing device, according to another embodiment of the present invention;

FIG. 5 is a sectional view to show a state where the dispensing device of FIG. 4 is placed on a stand; and

FIG. 6 is a sectional view to show another state where the dispensing device of FIG. 4 is placed on the stand.

### BEST MODE

The preferred embodiments of this invention will be described in further detail with reference to the accompanying drawings.

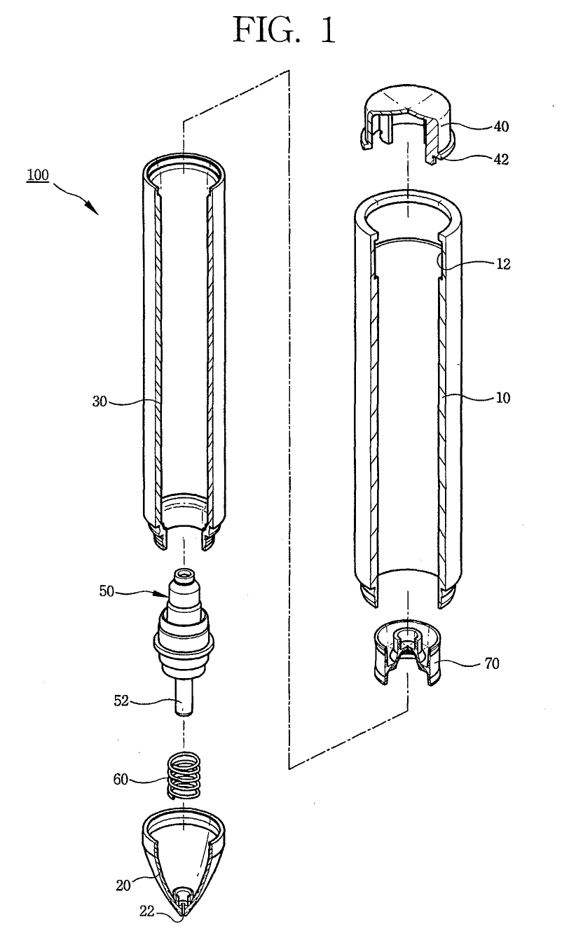

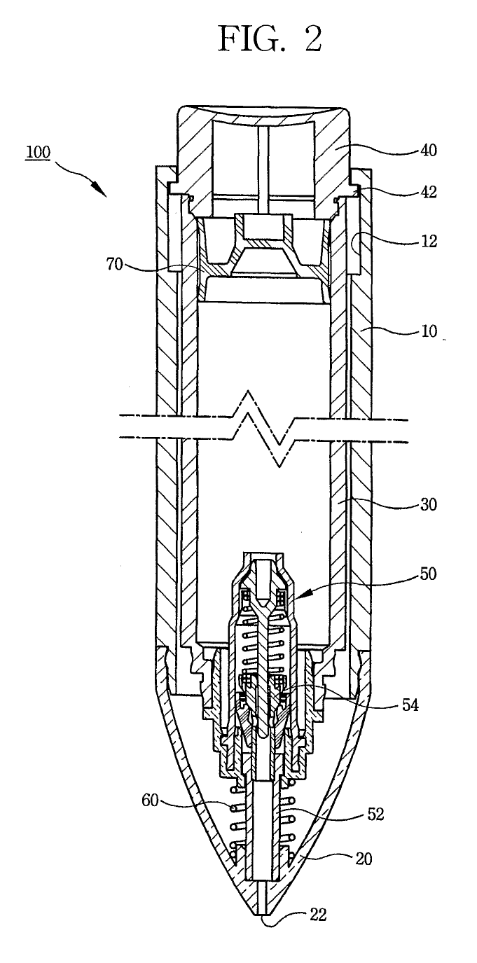

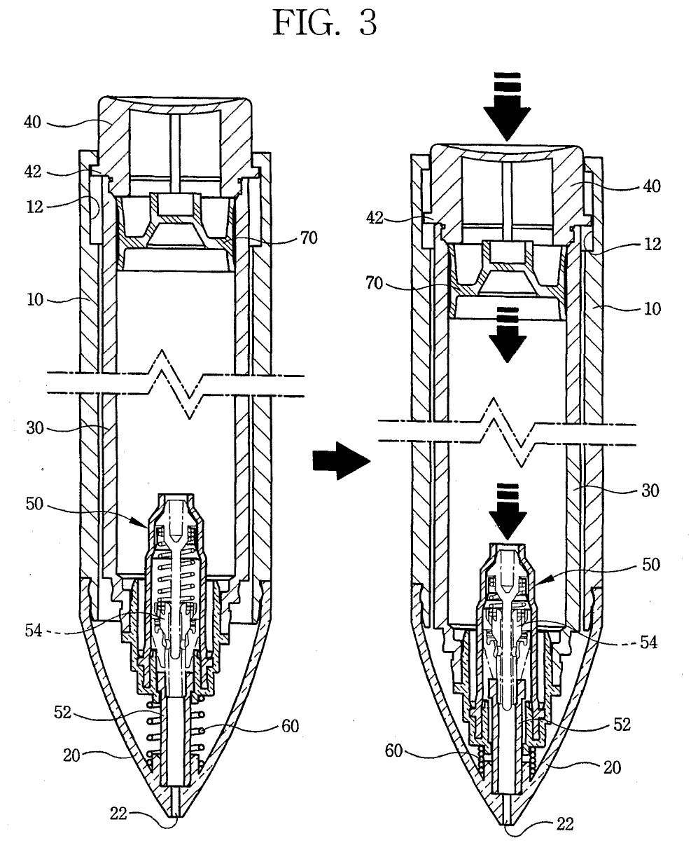

FIG. 1 is an exploded perspective view of a push-type dispensing device, according to this invention, FIG. 2 is a side sectional view of the push-type dispensing device, according to this invention, and FIG. 3 shows the operation of the push-type dispensing device, according to this invention.

As shown in FIGS. 1 to 3, the push-type dispensing device 100 of this invention includes an outer casing 10, a nozzle cap 20, an inner casing 30, a button 40, a dispenser 50, an elastic spring 60, and a plunger 70. The outer casing 10 has the shape of a barrel with a predetermined length. The nozzle cap 20 is mounted to a lower end of the outer casing 10. The inner casing 30 is housed in the outer casing 10. The button 40 is coupled to an upper end of the inner casing 30. The dispenser 50 is coupled to a lower end of the inner casing 30. The elastic spring 60 is disposed between the dispenser 50 and the nozzle cap 20. Further, the plunger 70 is provided in the inner casing 30.

In a detailed description, the outer casing 10 defines an external appearance of the dispensing device 100, and has the shape of a barrel that is opened at upper and lower ends thereof and has a predetermined length. Further, a guide groove 12 having a predetermined vertical length is provided on an inner circumferential surface of an upper portion of the outer casing 10, and engages with a guide protrusion 42 of the button 40, thus vertically guiding the guide protrusion 42. Thus, the length of the guide groove 12 is set to be equal to a vertical moving distance of the inner casing 30 and the button 40, thus limiting the range of motion of the inner casing 30. Further, a thread or snap is provided on a lower end of the outer casing 10 such that the nozzle cap 20 is fastened to the lower end of the outer casing 10.

The nozzle cap 20 has the shape of a hollow cone, with an orifice 22 of a predetermined, diameter bored through a central portion of the nozzle cap 20. Thus, while a pump stem 52 of the dispenser 50 contacts an inner surface of the nozzle cap 20, contents are discharged through the orifice 22. A support extends inwards from an outer circumference of the orifice 22 to a predetermined height, thus firmly supporting the pump stem 52 therein, with the elastic spring 60 fitted over the support. A thread or snap is provided on an inner circumference of an upper end of the nozzle cap 20 to correspond to the thread or snap of the outer casing 10.

The inner casing 30 has the shape of a barrel of a predetermined capacity to hold contents therein, and is housed in the outer casing 10. The inner casing 30 is opened at upper and lower ends thereof, with the button 40 coupled to the upper end of the inner casing 30, and the dispenser 50 coupled to the lower end of the inner casing 30. In this case, the inner casing 30 moves vertically along the inner surface of the outer casing 10 by a predetermined distance.

As described above, the button 40 is coupled to the upper end of the inner casing 30. An upper surface of the button 40 protrudes from the upper end of the outer casing 10 by a predetermined height to allow a user to push the button 40 with her hand. Further, the guide protrusion 42 is provided on the outer circumferential surface of a lower end of the button 40 to correspond to the guide groove 112 of the outer casing 10. Thus, when the button 40 moves upwards, so that the guide protrusion 42 comes into close contact with an upper end of the guide groove 12, the button 40 can not move upwards any more. Conversely, when the button 40 moves downwards, so that the guide protrusion 42 comes into close contact with a lower end of the guide groove 12, the button 40 can not move downwards any more.

The general construction of the dispenser 50 remains the same as a common dispenser. However, unlike the common dispenser, the dispenser 50 of this invention is disposed so that an end of the pump stem 52 is in close contact with an end of the orifice 22. As the inner casing 30 moves upwards and downwards, the pump stem 52 and a piston 54 execute a pumping action, thus dispensing a prescribed amount of contents.

In a detailed description, the dispenser 50 includes a cylinder, a check valve, a piston 54, the pump stem 52, a seal ring, a spring, and a cylinder cap. The cylinder is coupled to the mouth provided on the lower end of the inner casing 30, with an inlet port provided on an upper end of the cylinder. The check valve functions to control the ingress of contents into the inlet port. The piston 54 is installed in the cylinder, and executes the pumping action to discharge the contents. The pump stem 52 is coupled to the piston, and discharges the contents along a path. The seal ring is provided between the pump stem and the piston, and controls the discharge of the contents during the pumping action. The spring is disposed between an end of the piston and the check valve to bias the piston. The cylinder cap has at a central portion thereof a hole, and is coupled to the mouth of the inner casing while surrounding the cylinder. Since the dispenser constructed as described above is known to those skilled in the art, the dispenser will not be described in detail herein.

The elastic spring 60 is interposed between the cylinder cap of the dispenser 50 and the nozzle cap 20 while surrounding the pump stem 52 of the dispenser 50, which is in close contact with the nozzle cap 20. When the inner casing 30 moves downwards, the elastic spring 60 serves to restore the inner casing 30 to an original position thereof by the elasticity of the elastic spring 60.

The plunger 70 is in close contact with the inner surface of the inner casing 30, and pushes the contents held in the inner casing 30 toward the dispenser 50 in proportion to the discharged amount of contents. Thus, the plunger 70 has the shape of a cup to push the contents while being in contact with the inner surface of the inner casing 30.

The operational principle of the plunger 70 is as follows. When a prescribed amount of contents is dispensed by the pumping action of the dispenser 50, internal pressure of the inner casing 30 containing the contents is reduced in proportion to the discharged amount of contents. Since the internal pressure of the inner casing 30 is low, the plunger 70 is pulled downwards to maintain pressure equilibrium. According to such a principle, the plunger 70 is thrust to push the contents.

The operation of this invention constructed as described above will be described in detail with reference to the accompanying drawings.

First, a user holds the outer casing 10 of the dispensing device 100, and moves the orifice 22 provided on the lower end of the dispensing device 100 near a desired body part. In such a state, the user pushes the button 40 provided on the upper end of the dispensing device 100 using her thumb, in a similar manner to a mechanical pencil. When the button 40 is pressed down, the inner casing 30 coupled to the lower end of the button 40 moves downwards. Thereby, the dispenser 50 coupled to the lower end of the inner casing 30 is actuated. At this time, the inner casing 30 moves downwards by the length of the guide groove 12 of the outer casing 10 which guides the guide protrusion 42 of the button 40.

Meanwhile, when the inner casing 30 moves downwards while the pump stem 52 of the dispenser 50 is coupled to the orifice 22, the pump stem 52 and the piston 54 are retracted along the inner surface of the cylinder coupled to the cylinder cap, thus compressing the interior of the cylinder and simultaneously discharging the contents fed into the cylinder through the pump stem 52.

Therefore, the contents fed through the pump stem 52 are dispensed through the orifice 22, so that it is possible to directly dispense the contents to a desired body part.

Next, when the button 40 is released, the dispenser 50 is moved up by the elasticity of the elastic spring 60 which is interposed between the nozzle cap 20 and the dispenser 50, so that the inner casing 30 and the button 40 are restored to original positions thereof. That is, the inner casing 30 coupled to the dispenser 50 and the button 40 are simultaneously moved up by the elastic spring 60. Such upward movement is limited, because the guide protrusion 42 of the button 40 is stopped by the upper end of the guide groove 12 of the outer casing 10.

Meanwhile, as the dispenser 50 is moved up by the elastic spring 60, the pump stem 52 coupled to the orifice 22 and the piston 54 are advanced. Thereby, the contents flow through the inlet port into the cylinder, and, simultaneously, the plunger 70 moves downwards to push the contents toward the dispenser.

As such, when the user pushes the button several times, a series of operations is continuously performed. Thereby, a desired amount of contents is dispensed.

Further, the present invention further includes a stand 200 to safely support and stand the push-type dispenser 100 constructed as described above. This will be described below in detail.

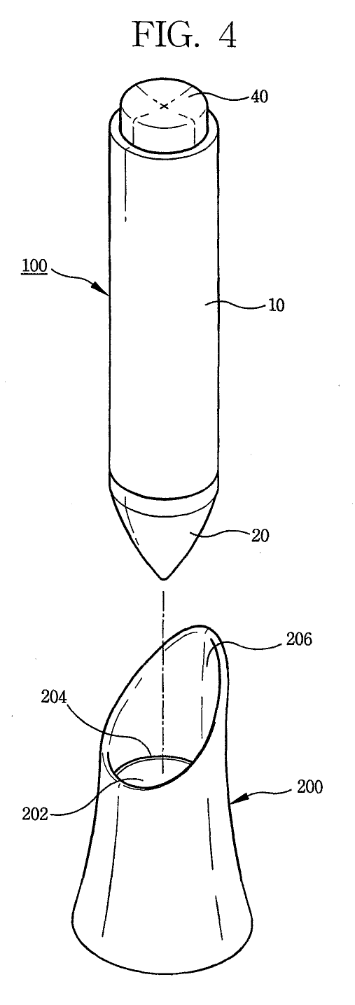

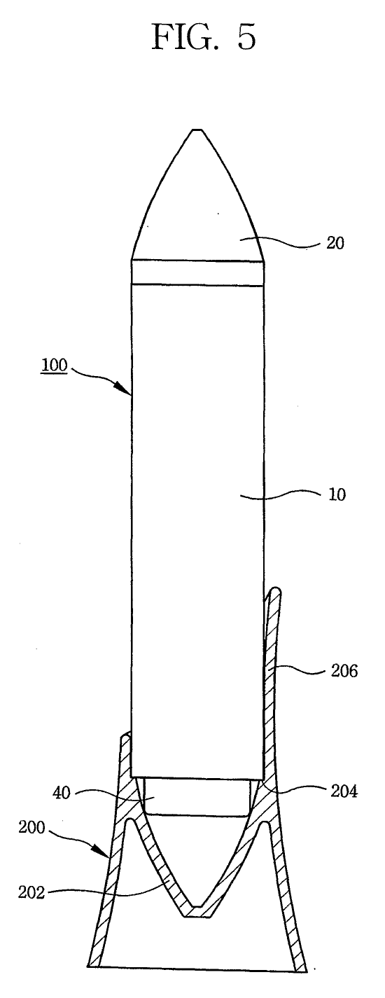

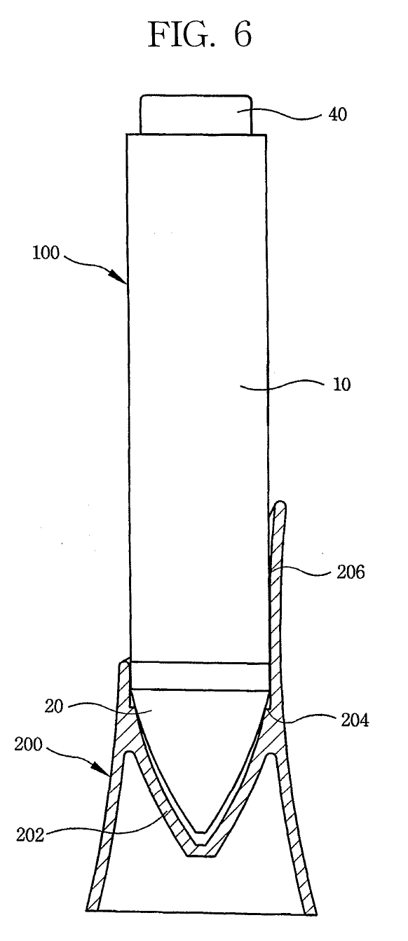

FIG. 4 is an exploded perspective view of a push-type dispensing device, according to another embodiment of the present invention, FIG. 5 is a sectional view to show a state where the dispensing device of FIG. 4 is placed on the stand, and FIG. 6 is a sectional view to show another state where the dispensing device of FIG. 4 is placed on the stand.

As shown in FIGS. 4 to 6, the push-type dispensing device of this invention includes the stand 200 so that an upper end of the dispensing device 100 having a button 40 or a nozzle cap 20 is selectively seated in the stand 200, thus supporting the dispensing device 100.

A conical seating recess 202 is formed in a central portion of the stand 200 so that the nozzle cap 20 is tightly inserted into the seating recess 202, thus supporting the dispensing device 100. Further, a support step 204 is provided along an upper end of the seating recess 202 so that an outer circumference of an upper end of the outer casing 10 is seated on the support step 204, thus supporting the dispensing device 100. That is, when the dispensing device 100 is in use, the dispensing device 100 is placed on the stand 200 such that the button 40 is located at a lower part of the dispensing device 100 and the outer circumference of the outer casing 10 is supported on the support step 204. Conversely, when the dispensing device 100 is not in use, the nozzle cap 20 is tightly inserted into the seating recess 202 to safely support the dispensing device 100. This prevents the contents from deteriorating due to the ingress of air into the orifice 22.

Further, a support piece 206 extends upwards from an outer edge of the support step 204 to a predetermined height, thus supporting the outer circumferential surface of the standing dispensing device 100. The support piece 206 prevents the dispensing device 100 from falling over, in addition to providing a good appearance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a push-type dispensing device, which is similar in construction to a mechanical pencil and is constructed so that a dispenser provided on a lower portion of the dispensing device is actuated when a button provided on an upper end of the dispensing device is pushed, thus dispensing a small amount of contents. Such a dispensing device is convenient to use and operate, and allows the discharged amount of contents to be easily controlled, thus preventing waste of the contents.

The present invention is provided with a stand for standing the dispensing device, thus being easy to store and display. Further, when the dispensing device is not in use, a nozzle cap is tightly inserted into a seating recess of the stand to safely support the dispensing device, thus preventing the contents from deteriorating due to contact with air.

1. A push-type dispensing device, comprising:
an outer casing having a barrel shape which is opened at upper and lower ends
thereof and has a predetermined length;
a nozzle cap having a hollow cone shape, and being fastened to a lower end of the outer casing, with an orifice formed at a center of the nozzle cap;
an inner casing housed in the outer casing, containing contents, such as cosmetics, and moving up and down by a predetermined distance;
a button coupled to an upper end of the inner casing to protrude upwards from the outer casing by a predetermined height, and actuated to move the inner casing downwards;
a dispenser coupled to a lower end of the inner casing, with a pump stem being provided on the dispenser such that a lower end of the pump stem is in close contact with the orifice, the dispenser dispensing a prescribed amount of contents by a pumping action of the pump stem and a piston;
an elastic spring interposed between a cylinder cap and the nozzle cap while surrounding the pump stem of the dispenser, and restoring the inner casing to an original position thereof using elasticity of the elastic spring when the inner casing has moved downwards; and
a plunger provided in the inner casing to be in close contact with an inner surface of the inner casing, and pushing the contents toward the dispenser when the prescribed amount of contents is dispensed.

2. The push-type dispensing device according to claim 1, wherein a guide groove having a predetermined vertical length is provided on an inner circumferential surface of an upper portion of the outer casing, and a guide protrusion is provided around a lower end of the button to correspond to the guide groove, thus, in cooperation with the guide groove, limiting vertical movement of the inner casing.

3. The push-type dispensing device according to claim 1, further comprising:
a stand, comprising:
a seating recess defined in a center of the stand so that the nozzle cap is tightly inserted into the seating recess, thus safely supporting and standing in the dispensing device;
a support step provided along an upper end of the seating recess so that an outer circumference of an upper end of the outer casing is seated on the support step, thus supporting the dispensing device; and
a support piece extending upwards from an outer edge of the support step to a predetermined height, and supporting an outer circumferential surface of the standing dispensing device.

4. The push-type dispensing device according to claim 2, further comprising:
a stand, comprising:
a seating recess defined in a center of the stand so that the nozzle cap is tightly inserted into the seating recess, thus safely supporting and standing in the dispensing device;
a support step provided along an upper end of the seating recess so that an outer circumference of an upper end of the outer casing is seated on the support step, thus supporting the dispensing device: and
a support piece extending upwards from an outer edge of the support step to a predetermined height, and supporting an outer circumferential surface of the standing dispensing device.
